(19) United States
(12) Patent Application Publication
(10) Pub. No.: US 2021/0072937 A1
(43) Pub. Date: Mar. 11, 2021

(54) APPARATUS AND METHOD FOR CUSTOMIZING SETTINGS BASED ON USER INTERACTIONS ON A MULTI-FUNCTION DEVICE

(71) Applicant: Xerox Corporation, Norwalk, CT (US)

(72) Inventors: Stephanie Jill Cruz, Ontario, NY (US); Timothy David Thomas, Fairport, NY (US); Kim P. Ciulla, Bloomfield, NY (US); Janine M. Gates, Rochester, NY (US); Michael William Barrett, Fairport, NY (US); Steven Vincent Rosekrans, Rochester, NY (US); Sooraj Kumar, Webster, NY (US); Connor Sterling Seiden, Webster, NY (US); Timothy Luke Dioguardi, Webster, NY (US); Paul Roberts Conlon, South Bristol, NY (US)

(21) Appl. No.: 16/567,843

(22) Filed: Sep. 11, 2019

(51) Int. Cl. G06F 3/12; H04N 1/00

(52) U.S. Cl. CPC G06F 3/1255; H04N 1/00517; G06F 3/1287; G06F 3/1204

(57) ABSTRACT

A method for customizing settings on a multi-function device (MFD) is disclosed. For example, the method is executed by a processor and includes monitoring user interactions with the MFD, determining that an interaction threshold is exceeded, customizing a setting on the MFD for the user in response to the interaction threshold being exceeded, and adjusting the setting from a default setting on the MFD in response to a subsequent login by the user on the MFD.

The present disclosure relates generally to multi-function devices (MFDs) and, more particularly, to MFDs that can automatically customize settings based on user interactions.

### BACKGROUND

Multi-function devices (MFDs) can be used to perform a variety of different functions. For example, MFDs can be used to copy documents, print documents, fax documents, and the like. Each job function may include a variety of different job attributes or features. For example, within a particular job function, the attributes may include paper size, single-sided or two-sided, color, number of copies, finishing options (e.g., collate, staple, etc.), and the like.

The MFD may display a default screen on a user interface when a user logs in to the MFD. In other words, different users may all be presented with the same starting screen and default settings when logging in to the MFD. However, different users may access different settings on the MFD.

### SUMMARY

According to aspects illustrated herein, there are provided a method and an MFD for customizing settings on the MFD. One disclosed feature of the embodiments is a method that monitors user interactions with the MFD, determines that an interaction threshold is exceeded, customizes a setting on the MFD for the user in response to the interaction threshold being exceeded, and adjusts the setting from a default setting on the MFD in response to a subsequent login by the user on the MFD.

Another disclosed feature of the embodiments is an MFD for customizing settings on the MFD. The MFD comprises a graphical user interface (GUI), a memory to store user interactions with the GUI and an interaction threshold, and a processor in communication with the GUI and the memory. The processor is to monitor user interactions with the GUI, determine that the interaction threshold is exceeded by the user interactions, customize a setting on the MFD for the user in response to the interaction threshold being exceeded, and adjust the setting from a default setting on the MFD in response to a subsequent login by the user on the MFD.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of a system of the present disclosure;

FIG. 2 illustrates a block diagram of an MFD that automatically adjusts settings based on user interactions of the present disclosure;

FIG. 3 illustrates example screenshots of a user interface of the MFD of the present disclosure;

FIG. 4 illustrates a flowchart of an example method for adjusting settings based on user interactions on an MFD of the present disclosure; and

FIG. 5 illustrates a high-level block diagram of an example computer suitable for use in performing the functions described herein.

To facilitate understanding, identical reference numerals have been used, where possible, to designate identical elements that are common to the figures.

### DETAILED DESCRIPTION

The present disclosure broadly discloses an apparatus and method for customizing settings based on user interactions on a multi-function device. As discussed above, MFDs can be used to perform various different job functions. However, different users may be presented with the same starting screen or default screen on the user interface (UI) of the MFD. Different users may access different settings or have different user interactions. Thus, having the same default screen after a user logs in to the MFD for different users may be inefficient.

The present disclosure may monitor user interaction with the MFD and, based on the interaction, the MFD may customize or adjust settings based on the user interactions. The user interactions may be monitored and learned locally by an MFD or consolidated across a network of MFDs. For example, the settings may include what is displayed on a first screen on the UI after a user logs in. For example, the user may repetitively use certain apps (for example, but not limited to, one touch apps, native apps, webapps, consolidated work-flows, and the like). Thus, these apps may be displayed in the first screen more prominently, ordered by use, and the like.

In one embodiment, the user may select the same settings based on a certain action. For example, when a user places documents in the document handler, the user may repeatedly use 8.5×11 inch paper and make 50 copies. Thus, when the user logs in and documents are detected in the document handler, the MFD may automatically adjust the settings to copy function, select 8.5 inch paper, and set the number of copies to 50. The interactions may be learned on a single MFD locally, or consolidated across a network of MFDs. As a result, the customized settings may be shown on any one of the networked MFDs when the user logs in to one of the networked MFDs.

In one embodiment, the customized first screen may be different for a user depending on which MFD the user is logged in to. For example, the user may perform a particular repetitive action on an MFD in one location and another repetitive action on a different MFD in another location. In other words, the interactions of the user may be learned locally by each MFD. Thus, the same user may have different first screens on different MFDs.

In one embodiment, the settings may include a default language for a particular user, a particular menu or screen which is often used by the user on the MFD, and the like. Thus, the present disclosure allows settings of the MFD to be automatically adjusted or customized based on user interactions of different users.

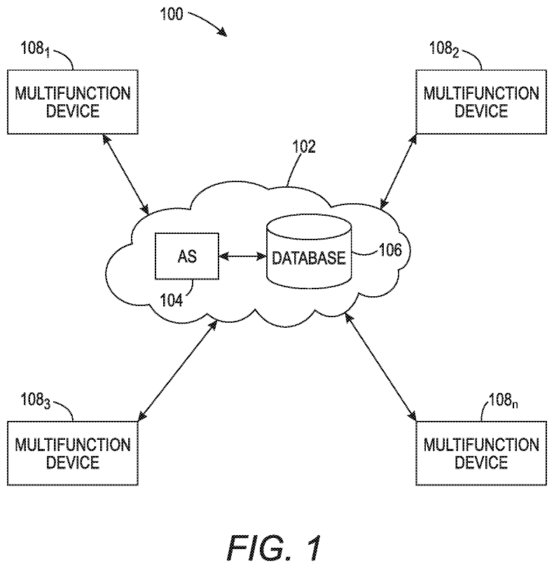

FIG. 1 illustrates an example system 100 of the present disclosure. In one embodiment, the system 100 may include a communication network 102 that includes an application server (AS) 104 and a database (DB) 106. The communication network 102 may be an Internet protocol (IP) network. The communication network 102 may be wide area network (e.g., across different geographic locations) or a local area network (e.g., a wireless network within a building).

It should be noted that the communication network 102 has been simplified for ease of explanation. The communication network 102 may include other devices or components that are not shown. For example, the communication network 102 may include routers, switches, gateways, firewalls, and the like.

The AS 104 may be a computing device that includes a processor and memory. The AS 104 may be communicatively coupled to the DB 106. The DB 106 may include a computer readable storage medium that may store various information or data. For example, DB 106 may store user profiles, user log-in credentials, and the like. When the custom settings for each user are created remotely by the AS 104 (as discussed below), the DB 106 may also store monitored user interactions, interaction thresholds, and the like.

In one embodiment, the AS 104 may be communicatively coupled to one or more multi-function devices (MFDs) 108₁-108ₙ (hereinafter also referred to individually as an MFD 108 or collectively as MFDs 108). The MFDs 108 may be located across different geographic locations or may be located across different locations within the same building (e.g., in different rooms, on different floors, within different departments, and the like). In one embodiment, data may be transmitted between the MFDs 108 and the AS 104 to perform the functions described herein. In some embodiments, the custom settings may be created locally by the MFD 108.

In other embodiments, the custom settings may be created remotely by the AS 104 and transmitted to any one of the MFDs 108. For example, a user may be logged in to the MFD 108₂ and the AS 104 may transmit the custom settings to the MFD 108₂, as discussed in further details below.

In one embodiment, the MFDs 108 may perform various job functions. For example, the MFDs 108 may print, copy, fax, scan, email documents, and the like. The MFDs 108 may provide a variety of different attributes or features with each job function. For example, the MFDs 108 may allow a user to select color, size, plex (e.g., single sided or double sided), resolution, finishing (e.g., collate, staple, hole punch, and the like), specify email recipients, and the like.

The MFDs 108 may also have various default settings. For example, a first screen or a welcome screen after a user logs in to the MFD 108 may have certain short-cuts, icons, or options. Each short-cut, icon, or option may have associated settings or values. The MFDs 108 may also have a default language setting, color scheme, formatting options, and the like. As discussed in further details below, these default settings may be changed in accordance with custom settings that can be created for each user. When the custom settings are created locally by the MFD 108, the MFD 108 may also be modified to include functionality to monitor user interactions and to create the custom settings.

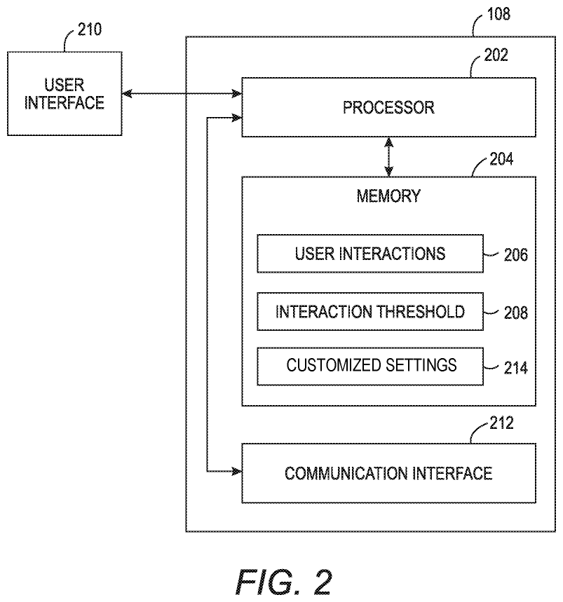

FIG. 2 illustrates an example of the MFD 108 that is modified to perform the functions of the present disclosure. In one embodiment, the MFD 108 may include a processor 202, a memory 204, a user interface (UI) 210, and a communication interface 212. The processor 202 may be communicatively coupled to the memory 204, the UI 210, and the communication interface 212. The processor 202 may execute instructions stored in the memory 204 to perform the functions described herein (e.g., creating the customized settings).

In one embodiment, the UI 210 may be a graphical user interface (GUI). The UI 210 may include a display and input buttons. In one embodiment, the UI 210 may include a touch screen display and users may directly select short-cuts, icons, or menu options by interacting with the display. For example, the selection may be made by touching the display, a verbal command, with an external input device such as a pointer or mouse, a gesture, and the like.

In one embodiment, the communication interface 212 may be a wired or wireless communication interface 212. For example, the communication interface 212 may be an Ethernet port, a wireless radio, and the like. The communication interface 212 may establish a communication path to the AS 104 via the network 102.

In one embodiment, the memory 204 may be a non-transitory computer readable medium. The memory 204 may be a random access memory (RAM), a read only memory (ROM), a hard disk drive, a solid state drive, or any combination thereof.

In one embodiment, the memory 204 may include user interactions 206, an interaction threshold 208, and customized settings 214. In one example, the user interactions 206 may be monitored user interactions of a user or different users on an MFD 108 that can be stored. For example, each time a user interacts with one of the MFDs 108, the interaction with the MFD 108 is stored in the user interactions 206.

For example, a first user may log in to the MFD 108₁. The user may make 100 copies of a document on 8.5×11 inch paper. The user may select a finishing option of stapling. Such a user interaction may be stored for the first user in the user interactions 206. A second user may log in to the MFD 108₁ and scan a document and enter three recipients to receive the scanned document. Such a user interaction may be store for the second user in the user interactions 206.

In one embodiment, the interaction threshold 208 may include a threshold for a number of times a user interaction is repeated. In one embodiment, the threshold may be associated with a predefined time window or within a rolling time period. For example, the threshold may be 10 repetitions of the same user interaction by the same logged in user. In one example, the threshold may be monitored within a 24 hour time period or a continuous rolling 24 hour time period. It should be noted that the threshold may be any value (e.g., 5, 12, 20, and the like). The time period may be any time period (e.g., 12 hours, 2 days, 1 week, 1 month, and the like).

In one embodiment, the user interactions 206 and the interaction threshold 208 may be monitored and accumulated over multiple different MFDs 108. For example, the user may interact with the MFD 108₁, 108₂, and 108₃. The user interactions 206 on each MFD 108₁-108₃ may be accumulated to determine whether the interaction threshold 208 is exceeded.

In one embodiment, the user may have different user interactions 206 on different MFDs 108. Thus, the user may have different customized settings 214 stored in the memory 204 of different MFDs 108. For example, the user may always scan and email a document to the same group of recipients when using the MFD 108₁. Thus, the customized settings 214 for the user on the MFD 108₁ may include displaying on the UI 210, after the user logs in to the MFD 108₁, the scan job function with an option to email and the recipient field auto filled with the same group of recipients.

The user may always make 100 copies on 8.5×11 inch paper with three-hole punch and stapling when using the MFD 108₂. Thus, the customized settings 214 for the user on the MFD 108₂ may include displaying on the UI 210, after the user logs in to the MFD 108₁, the copy job function with the number of copies set to 100, 8.5×11 inch paper selected and the finishing options of three-hole punch and stapling.

In one embodiment, the user interactions 206 and the interaction threshold 208 may be tracked for a group of users in a particular department, job code, or job description. For example, the user interactions 206 of a group may be tracked, and when the group exceeds the interaction threshold 208, locally by a single MFD 108 or accumulated over several MFDs 108, a customized setting 214 may be created for the group.

For example, a customized setting 214 may be created for an accounting department. When a user logs into the MFD 108, the MFD 108 may recognize that the user is from the accounting department and automatically implement the customized settings 214 associated with the accounting department on the MFD 108.

In one embodiment, the customized settings 214 may also include changing default settings associated with a global setting. For example, the user may also change the language to Spanish instead of English. As a result, the customized setting 214 for the user may include automatically changing the language setting from English to Spanish when a user logs in to any MFD 108.

In another example, the user may repeatedly use a particular application on an MFD 108. Thus, the default first screen on the UI 210 that is displayed after the user logs in may show the app that is frequently used instead of default icons or options.

Thus, when the interaction threshold 208 is exceeded, the processor 202 may determine that a repetitive user interaction is detected and automatically create a customized setting 214. In one embodiment, the processor 202 may provide a notification or message on the UI 210 asking the user if the user would like to create the customized setting 214. If the user confirms the option, the processor 202 may create the customized setting 214.

As noted above, in some instances, the AS 104 may perform the creation of the customized settings 214. When the AS 104 creates the customized settings 214, the DB 106 may store the user interactions 206, the interaction threshold 208, and the customized settings 214.

The user interactions of each user on each MFD 108 may be transmitted to the AS 104 via the communication interfaces 212 of the MFDs 108. Thus, the customized settings 214 may be created by the AS 104 based on user interactions 206 that are collected over different MFDs 108 at different locations for the same user.

In one embodiment, the different customized settings 214 may be created for the same user depending on which MFD 108 the user is using. When the AS 104 detects that the user has logged in to a particular MFD 108, the customized settings 214 may be transmitted to the MFD 108. The MFD 108 may then change the default settings to the customized settings 214, which can be set or displayed after the user logs in to the MFD 108.

In one embodiment, the user may log in to a different MFD 108. The AS 104 may determine which customized settings 214 are associated with the user and the particular MFD 108 and transmit the customized settings 214 to the different MFD 108 logged in to by the user. The different MFD 108 may then change the default settings in accordance with the customized settings 214 received from the AS 104.

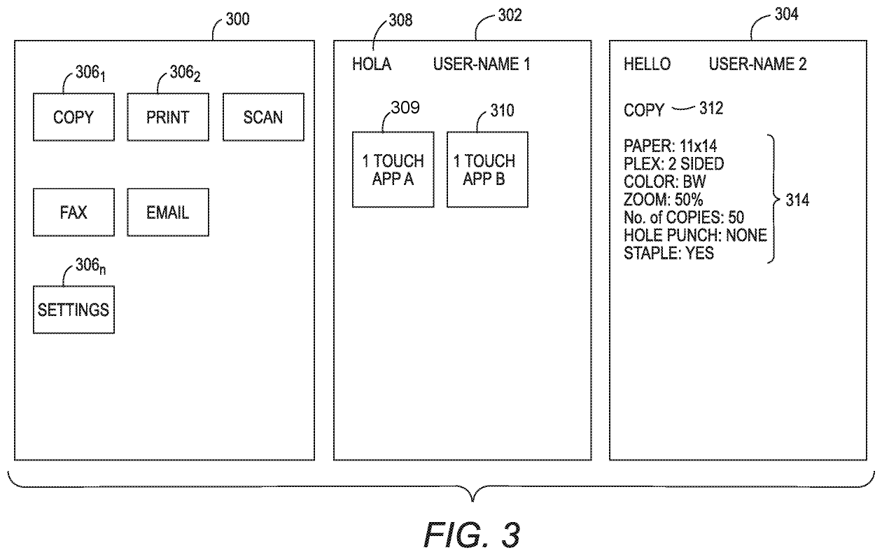

FIG. 3 illustrates example screenshots 300, 302, and 304 of the UI 210 of the MFD 108. In one embodiment, the user may interact with the MFD 108, and the customized settings 214 may be automatically created, as discussed above.

In one embodiment, the screenshot 300 illustrates an example default display and settings of the MFD 108. For example, the default display may be the display that is programmed after manufacturing for each MFD 108. In other words, without any changes, MFDs 108 of the same model and type may have the same default settings. For example, the display may show standard available short-cuts. The short-cuts may be icons, text, a verbal representation (e.g., using a voice command to call the short-cut), a gesture representation (e.g., using a camera on the MFD to capture and interpret a gesture by the user), and the like. FIG. 3 illustrates the short-cuts as icons 306₁-306ₙ (hereinafter also referred to individually as an icon 306 or collectively as icons 306). The icons 306 may be associated with available job functions such as copy, print, scan, fax, email, and the like. One of the icons 306 may allow a user to select different settings.

In one embodiment, each one of the job functions may have default selections of values or features. For example, the copy job function may have default settings of 1 copy, 8.5×11 inch paper, 100% zoom, all finishing options turned off, and the like. Selecting the copy icon 306₁ may display a second menu of options that allow a user to modify the settings for the copy job function.

However, as discussed above, customized settings 214 can be created for different users on the MFD 108. In one example, the customized settings 214 of the user may change the default language setting to Spanish and change the default first screen to show applications that the user frequently uses.

The screenshot 302 illustrates an example screen on the UI 210 that is shown after the user logs in to the MFD 108. Notably, the settings, information that is displayed, or the options that are available, are different than the default settings and screenshot 300 shown after a user logs in to the MFD 108 without any customized settings 214.

As shown in the screenshot 302 a greeting or text 308 may be in Spanish. The icons 309 and 310 may be associated with apps that the user frequently uses. The apps may be short-cuts for a series of different jobs or settings performed by the MFD 108. Notably, the first screen after the user logs in to the MFD 108 as shown by the screenshot 302 has changed from the default settings shown by the screenshot 300. In other words, if the customized settings 214 of the user were deleted, the screenshot 300 would be shown to the user after the user logged in to the MFD 108 instead of the screenshot 302.

In another example, the customized settings 214 for the user may include a different arrangement of the icons 306. In one embodiment, the icons 306 may be arranged based on frequency of use. For example, the user may frequently email documents on the MFD 108. Thus, the email icon 306 may be rearranged to be the first icon 306 that is displayed after the user logs in to the MFD 108.

The screenshot 304 illustrates a customized display or setting for a second user. In one embodiment, the customized settings 214 may be activated in response to detection of a particular interaction with the MFD 108. In other words, rather than changing the default screen after the user logs in to the MFD 108, the display may be automatically changed based on the customized settings 214 in response to detecting a particular action.

For example, whenever the user places documents in the MFD 108 (e.g., on a document handler on top of the MFD 108, on a platen/glass of the MFD 108, a document feeder of the MFD 108, and the like), the user may always make copies with the same selected features. For example, the user may make 50 copies on 11×14 inch paper, two-sided that is reduced by 50%. The user may also select stapling. A customized setting 214 may be created that is associated with the user and this user interaction 206.

When the second user logs in to the MFD 108, the default screenshot 300 may be displayed. However, the user may place documents in the MFD 108 (e.g., on a document handler on top of the MFD 108, on a platen/glass of the MFD 108, a document feeder of the MFD 108, and the like). The MFD 108 may detect the documents and execute the customized settings 214 associated with this user and this action. In response, the MFD 108 may automatically change the display to the screenshot 304 and change the default settings for the copy job function to the settings associated with the customized settings 214.

As shown in the screenshot 304, a job function 312 of copy may be displayed. Features 314 associated with the job function 312 may be automatically changed from the default settings to the settings associated with the customized settings 214. For example, the paper size may be set to A4 paper, the plex may be changed to two-sided, the color may be set to black and white, the zoom may be set to 50%, the number of copies may be set to 50 and the staple finishing option may be turned on to “yes”.

In one embodiment, the order of the features associated with the job function 312 may also be arranged based on frequency of use. For example, if the second user frequently changes the number of copies and the zoom percentage, then the features of the zoom percentage and the number of copies may be displayed at the top of the display.

Notably, the users do not touch or select any option on the UI 210 after the documents are loaded in to the document handler. Rather, based on the multiple observed prior user interactions 206 and learned behavior, the MFD 108 may automatically know what actions the users are about to perform and automatically adjust the settings.

In one embodiment, the MFD 108 may provide a confirmation option. For example, the MFD 108 may ask the second user if these customized settings are acceptable. If for some reason the user is attempting to perform a different option, the user may decline the customized settings and the default screenshot 300 may be shown again to allow the second user to select the appropriate settings.

In one embodiment, multiple customized settings 214 may be associated with the same action. For example, the second user may equally either scan the document with particular settings or copy the document with particular settings when documents are placed in the document handler. When multiple customized settings 214 are available in response to an action, the MFD 108 may provide a notification, or a reminder, with the available customized settings 214 in the UI 210 and allow the user to select the customized setting 214.

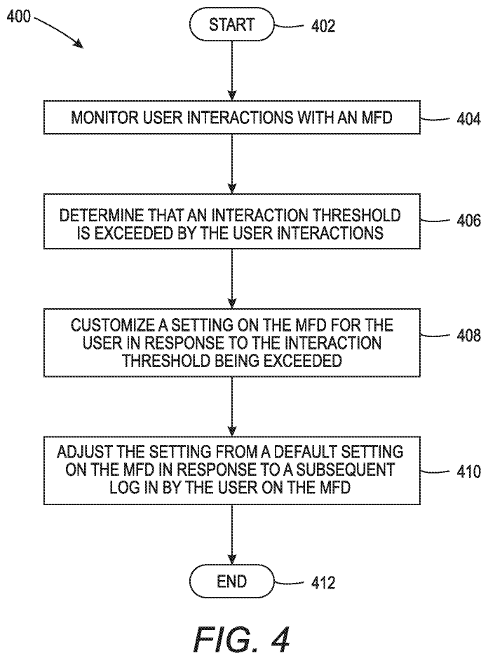

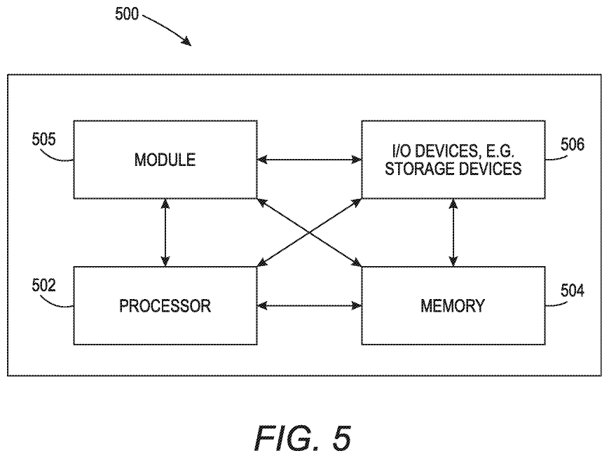

FIG. 4 illustrates a flowchart of an example method 400 for customizing settings on an MFD of the present disclosure. In one embodiment, one or more blocks of the method 400 may be performed by the application server 102, the MFD 108, or a computer/processor that controls operation of an MFD as illustrated in FIG. 5 and discussed below.

At block 402, the method 400 begins. At block 404, the method 400 monitors user interactions with the MFD. For example, the MFD or a remotely located AS may monitor which job functions are selected, the attributes that are selected for a particular job function, and the like. The interactions may be monitored over a period of time (e.g., several hours, a day, a week, and the like).

In one embodiment, the interactions may be stored as they are tracked for multiple users. In one embodiment, the method 400 may also track the time period and the number of times the user interactions occur within the time period or a rolling time period. Each series of user interactions for each user may be tracked on each of the MFDs to determine if a particular user interaction is repeated.

At block 406, the method 400 determines that an interaction threshold is exceeded by the user interactions. In one embodiment, the interaction threshold may be a repetition threshold. For example, the interaction threshold may be 5, 10, or 20, or any other desired value. The repetition threshold may track whether a particular job function and attributes are repeated a predefined number of times. In one embodiment, the repetition threshold may also include a time window or a rolling time window (e.g., performing the same job function and attributes 10 times within a 24 hour period).

At block 408, the method 400 customizes a setting on the MFD for the user in response to the interaction threshold being exceeded. For example, the setting may be customized to change settings from a default setting of the MFD. The customized setting may change information or options available on a first screen that is displayed after the user logs in to the MFD. The customized settings may change an arrangement of the icons or what information is displayed on the first screen that is displayed after the user logs in to the MFD. The customized settings may change values for features associated with different job functions of the MFD. The customized settings may change a global setting such as a language, a security setting, and the like.

In one embodiment, the customized setting may be associated with a particular action or event. For example, when a document is placed in a document handler, the customized setting may change the display to present the job function that is automatically selected and the values associated with features for the job function that are automatically selected. In another example, when a document is placed on a scanning window of the MFD, the customized setting may change the display to present a different job function that is automatically selected and values associated with features for the different job function, and so forth. In another example, when a certain job function is repeatedly selected after logging into the MFD, the customized setting may automatically display the job function after a user logs in to the MFD.

At block 410, the method 400 adjusts the setting from a default setting on the MFD in response to a subsequent login by the user on the MFD. For example, after the customized settings are created for the user and/or for a particular MFD in a particular location, the customized settings may be executed the next time the user logs in to the MFD.

For example, the default settings that are shown in the first screen of the UI of the MFD after the user logs in may be changed based on the customized settings associated with the user. In one embodiment, the adjustments may be made based on a detection action after the user logs in to the MFD. For example, the customized settings may be executed after a document is placed in the document handler of the MFD. At block 412, the method 400 ends.

FIG. 5 depicts a high-level block diagram of a computer that is dedicated to perform the functions described herein. As depicted in FIG. 5, the computer 500 comprises one or more hardware processor elements 502 (e.g., a central processing unit (CPU), a microprocessor, or a multi-core processor), a memory 504, e.g., random access memory (RAM) and/or read only memory (ROM), a module 505 for customizing settings on an MFD, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 505 for customizing settings on an MFD (e.g., a software program comprising computer-executable instructions) can be loaded into memory 504 and executed by hardware processor element 502 to implement the steps, functions or operations as discussed above in connection with the example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for customizing settings on an MFD (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for customizing settings on a multi-function device (MFD), comprising:
monitoring, by a processor, user interactions with the MFD, wherein the monitoring comprises monitoring the user interactions across a plurality of different MFDs at different locations;
determining, by the processor, that an interaction threshold is exceeded by the user interactions across the plurality of different MFDs;
customizing, by the processor, a first setting on a first MFD of the plurality of MFDs at a first location and a second setting on a second MFD of the plurality of MFDs at a second location for the user in response to the interaction threshold being exceeded across the plurality of different MFDs, wherein the first setting on the first MFD is different than the second setting on the second MFD; and
adjusting, by the processor, the first setting from a default setting on the first MFD and a second setting from a default setting on the second MFD in response to a subsequent login by the user on the first MFD or the second MFD.

2. (canceled)

3. The method of claim 1, wherein the user interaction comprises a change to a default setting.

4. The method of claim 1, wherein the user interaction comprises a selection of a setting of a feature associated with a job function.

5. The method of claim 1, wherein the user interaction comprises placement of a document in the MFD and an associated selection of features in response to the placement of the document in the MFD.

6. The method of claim 1, wherein the interaction threshold comprises a number of selections.

7. The method of claim 1, wherein the interaction threshold is associated with a particular MFD in a particular location.

8. The method of claim 1, wherein the setting comprises an arrangement of short-cuts that are displayed on a first screen of the UI after the user logs in to the MFD.

9. The method of claim 1, wherein the setting comprises a selection of an option associated with a feature of a job function.

10. The method of claim 1, wherein the adjusting comprises:
detecting, by the processor, that the user is logged in to the MFD, wherein the MFD remotely located; and
transmitting, by the processor, a custom setting associated with the user to the MFD.

11. A multi-function device (MFD) to create customized settings on the MFD, comprising:
a graphical user interface (GUI);
a memory to store user interactions with the GUI and an interaction threshold; and
a processor in communication with the GUI and the memory, wherein the processor is to:
monitor the user interactions with the GUI, wherein the monitoring comprises monitoring the user interactions across a plurality of different MFDs at different locations;
determine that the interaction threshold is exceeded by the user interactions across the plurality of different MFDs;
customize a first setting on a first MFD of the plurality of MFDs at a first location and a second setting on a second MFD of the plurality of MFDs at a second location for the user in response to the interaction threshold being exceeded across the plurality of different MFDs, wherein the first setting on the first MFD is different than the second setting on the second MFD; and
adjust the first setting from a default setting on the first MFD and a second setting from a default setting on the second MFD in response to a subsequent login by the user on the first MFD or the second MFD.

12. The MFD of claim 11, further comprising:
a communication interface to communicate with a remotely located server to transmit the user interactions to the remotely located server.

13. The MFD of claim 11, wherein the user interaction comprises a change to a default setting.

14. The MFD of claim 11, wherein the user interaction comprises a selection of a setting of a feature associated with a job function.

15. The MFD of claim 11, wherein the user interaction comprises placement of a document in the MFD and an associated selection of features in response to the placement of the document in the MFD.

16. The MFD of claim 11, wherein the interaction threshold comprises a number of selections.

17. The MFD of claim 11, wherein the interaction threshold is associated with a particular MFD in a particular location.

18. The MFD of claim 11, wherein the setting comprises an arrangement of short-cuts that are displayed on a first screen of the UI after the user logs in to the MFD.

19. The MFD of claim 11, wherein the setting comprises a selection of an option associated with a feature of a job function.

20. A method for customizing settings on a multi-function device (MFD), comprising:
monitoring, by a processor, changes to default settings selected by a user on the MFD over a period of time, wherein the monitoring comprises monitoring the user interactions across a plurality of different MFDs at different locations;
determining, by the processor, that an interaction threshold is exceeded across the plurality of different MFDs by a number of times the changes to the default settings are selected by the user within the period of time;
providing, by the processor, an option to customize a first setting on a first MFD of the plurality of different MFDs and a second setting on a second MFD of the plurality of MFDs for a user in response to the interaction threshold being exceeded across the plurality of different MFDs;
customizing, by the processor, the first setting on the first MFD and the second setting on the second MFD for the user in response to receiving a confirmation to create different customized settings on the first MFD and the second MFD, wherein the first setting on the first MFD is different than the second setting on the second MFD; and
adjusting, by the processor, the first setting from the default settings on the first MFD and the second setting from the default settings on the second MFD in response to a subsequent login by the user on the first MFD or the second MFD.
